(19) United States
(12) Patent Application Publication
(10) Pub. No.: US 2018/0055156 A1
(43) Pub. Date: Mar. 1, 2018

(54) RATCHET STRAP CONTAINMENT BAG

(71) Applicant: Benjamin Bruce BRADY, Katy, TX (US)

(72) Inventor: Benjamin Bruce Brady, Katy, TX (US)

(21) Appl. No.: 15/658,946

(22) Filed: Jul. 25, 2017

Related U.S. Application Data
(60) Provisional application No. 62/378,341, filed on Aug. 23, 2016.

(51) Int. Cl. A44B 99/00

(52) U.S. Cl. CPC A44B 99/00; B60P 7/16

(57) ABSTRACT

A ratchet strap containment bag with elastic openings at two opposing ends, through which tensioned portions of the ratchet strap may pass.

This application claims the benefit of the filing date U.S. provisional application Ser. No. 62/378,341, filed 23 Aug. 2016, which is incorporated herein by reference.

This application relates to a ratchet strap containment bag with elastic openings at two opposing ends, through which tensioned portions of the ratchet strap may pass.

### BRIEF DESCRIPTION OF THE DRAWINGS

The following drawings illustrate the concepts of the present invention. Illustrations of an exemplary device are not necessarily drawn to scale.

FIG. 1 is a view of an inside of an embodiment of the ratchet strap containment bag in an open and empty condition.

FIG. 2 is a view of the outside of the embodiment of FIG. 1 in a closed condition.

FIG. 3 is a view of the outside of the embodiment of FIG. 1 in a closed condition with a ratchet strap passing through the opposing elastic openings.

FIG. 4 is an enlarged partial view of one end of the embodiment shown in FIG. 3.

FIG. 5 is a view of the outside of the embodiment of FIG. 1 in an open and empty condition.

FIG. 6 is a view of the inside of the embodiment of FIG. 1, in an open condition with a ratchet mechanism and attached ratchet strap placed on the ratchet strap containment bag.

### DETAILED DESCRIPTION

While the embodiments described can take many different forms, specific embodiments illustrated in the drawings will be described with the understanding that the present disclosure is to be considered an exemplification of the principles of the invention, and is not intended to limit the invention to a specific embodiment illustrated.

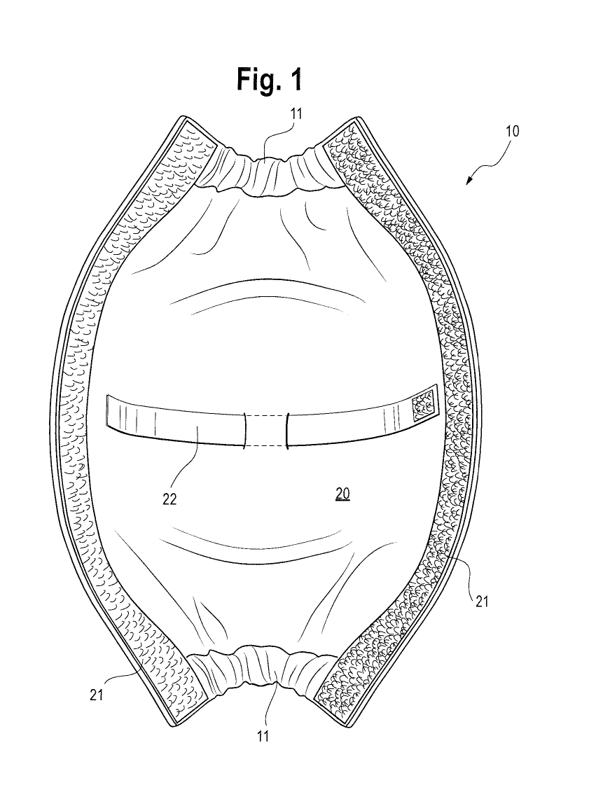

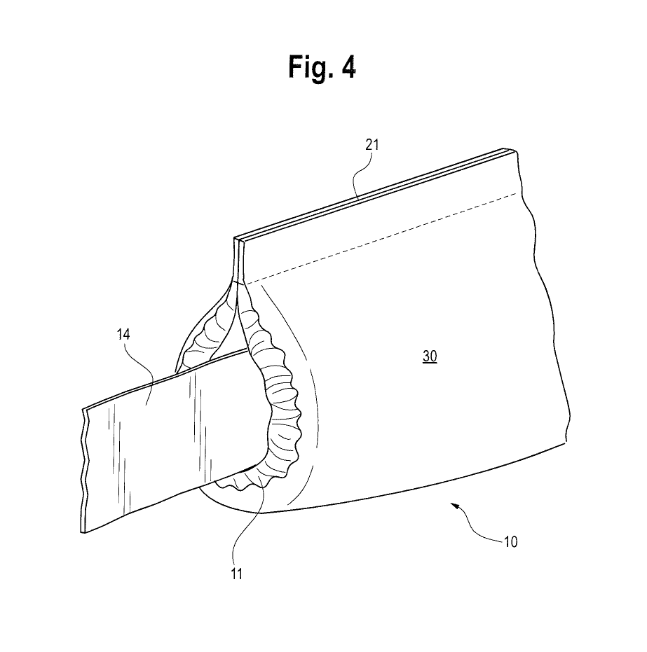

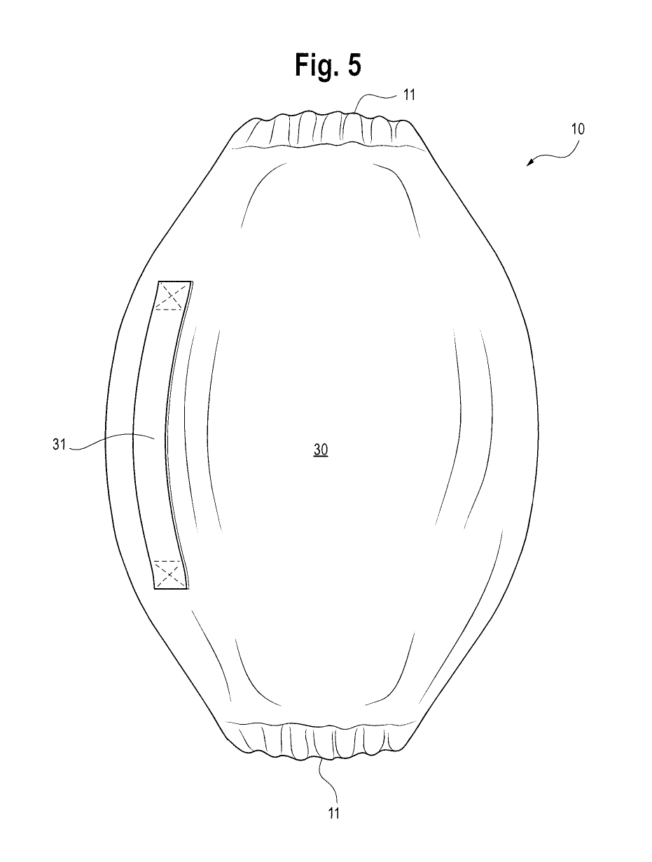

FIGS. 1-6 illustrate an exemplary embodiment of a ratchet strap containment bag 10. FIGS. 1 and 5 show an inside 20 and an opposite outside 30, respectively, of the ratchet strap containment bag 10 in an open and empty condition. The ratchet strap containment bag 10 comprises a sheet of flexible material. For example, the flexible material may comprise one or more of cotton, canvas, duck cloth, and nylon.

In some embodiments, the sheet of flexible material has opposing first and third ends 11, and opposing second and fourth ends, each of the second and fourth ends being between the first and third ends. Respective strips 21 of hook and loop material are attached to at least a portion of each of the second and fourth ends. For example, the strips 21 can be sewed to the respective second and fourth ends. As another example, strips 21 can be attached to the respective second and fourth ends using an adhesive.

In some embodiments, a strip of elastic material is attached to at least a couple of points of the first end 11, and a strip of elastic material is attached to at least a couple of points of the third end 11. The elastic material can be stretched and relaxed between a relaxed condition and a stretched condition. The elastic material is restrained to remain adjacent to the respective first and third ends 11, so that a length of the first or third end 11 is pulled shorter than it was originally when the elastic strip is allowed to resume its relaxed condition. For example, each of the first and third ends 11 can be folded over and sewn closed to form a closed compartment, in which the respective strip of elastic material is retrained.

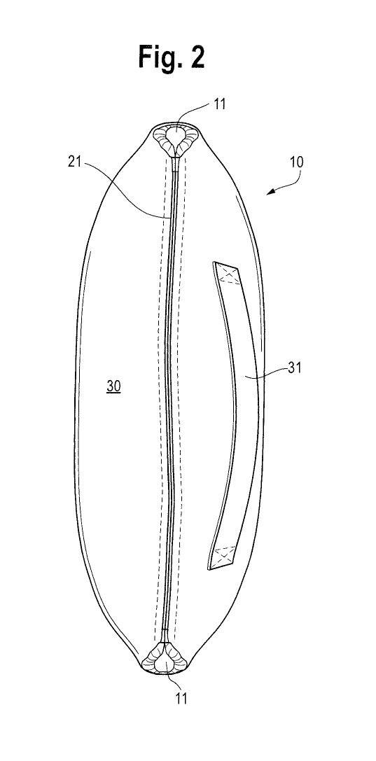

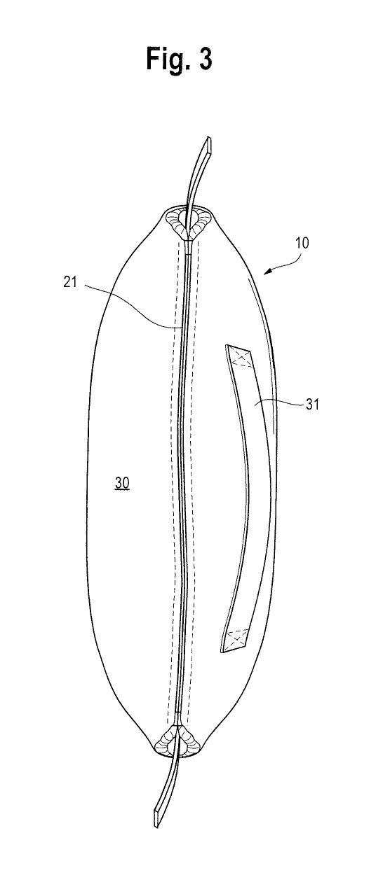

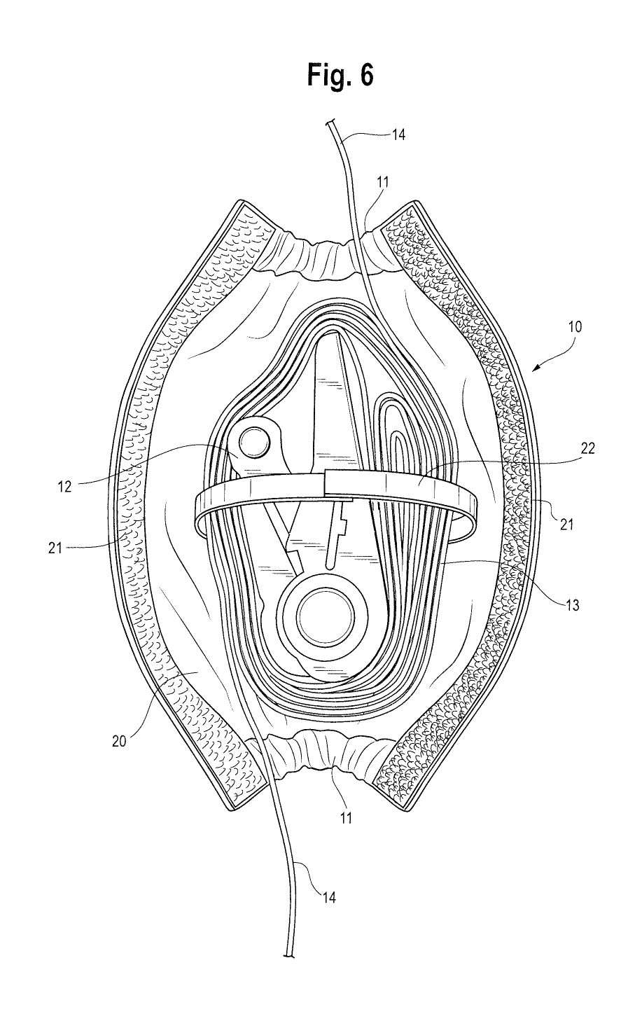

In some embodiments and as best illustrated in FIGS. 3 and 6, the sheet of flexible material can be wrapped around, and can fully contain, a ratchet mechanism 12 and an untensioned portion 13 of a ratchet strap. As illustrated in FIGS. 2-4 and 6, the ratchet strap containment bag 10 is formed by removably joining to each other the strips 21 of hook and loop material that are attached to the second and fourth ends. When the ratchet strap containment bag 10 is in that closed condition, first and third ends 11 become elastic openings through which tensioned portions 14 of the ratchet strap may pass. Consequently, the ratchet strap containment bag 10 can store a ratchet mechanism 12 and a ratchet strap when not in use, but also can contain the ratchet mechanism 12 and the untensioned portion 13 of the ratchet strap when they are in use securing and hauling loads.

The ratchet strap containment bag 10 provides a way to quickly and easily secure the ratchet mechanism 12 and the untensioned portion 13 of the ratchet strap once the ratchet strap is in place with the intended load secured. The ratchet strap containment bag 10 provides protection for a metallic ratchet mechanism 12, and provides a barrier between the ratchet mechanism 12 and fragile loads. It prevents the loose end of untensioned portion 13 of the ratchet strap from getting tangled, or from interfering with the secured load or with a vehicle on which the load is secured.

The ratchet strap containment bag 10 can be provided in any desired size to accommodate different sizes of ratchet mechanisms 12. In some embodiments, especially for larger ratchet strap containment bags 10, a handle 31 is attached to the outside 30 of the ratchet strap containment bag 10, as seen in FIGS. 2, 3 and 5. The handle 31 can be useful, particularly for carrying the ratchet strap containment bag 10 when it is being used to store a ratchet mechanism 12 and a ratchet strap that are not in use.

In some embodiments, at least one securing strap 22 is attached to the inside 20 of the ratchet strap containment bag 10, as seen in FIGS. 1 and 6. The securing strap 22 can be useful for keeping at least part of the untensioned portion 13 of the ratchet strap organized and untangled within the ratchet strap containment bag 10.

From the foregoing, it will be understood that numerous modifications and variations can be effectuated without departing from the true spirit and scope of the novel concepts of the present invention. It is to be understood that no limitation with respect to the specific embodiments illustrated and described is intended or should be inferred.

1. A ratchet strap containment bag, comprising:
a sheet of flexible material having a first side and an opposite second side, having a first end and an opposing third end, having a second end and an opposing fourth end, the second end being between the first and third ends, and the fourth end being between the first and third ends;
a first strip of elastic material that can be stretched and relaxed between a relaxed condition and a stretched condition, that remains attached to at least first and second points of the first end when the first strip is in its stretched condition, and that is restrained to remain adjacent to the first end between the first and second points of the first end, so that a length of the first end is pulled shorter than it was originally when the first strip is allowed to resume its relaxed condition;
a third strip of elastic material that can be stretched and relaxed between a relaxed condition and a stretched condition, that remains attached to at least first and second points of the third end when the third strip is in its stretched condition, and that is restrained to remain adjacent to the third end between the first and second points of the third end, so that a length of the third end is pulled shorter than it was originally when the third strip is allowed to resume its relaxed condition;
a second strip of hook and loop material attached to at least a portion of the second end;
a fourth strip of hook and loop material attached to at least a portion of the fourth end;
wherein the sheet can be wrapped around, and can fully contain, a ratchet mechanism and an untensioned portion of a ratchet strap when the hook and loop materials of the second and fourth strips are removably joined to each other, forming a containment bag with elastic openings at the first and third ends through which tensioned portions of the ratchet strap may pass.

2. The ratchet strap containment bag of claim 1, wherein at least one of the second and fourth strips is sewed to the respective second or fourth end.

3. The ratchet strap containment bag of claim 1, wherein at least one of the first and third ends is folded over and sewn closed to form a closed compartment in which the respective first or third strip is restrained.

4. The ratchet strap containment bag of claim 1, further comprising a handle attached to the first side of the sheet, wherein the first side will be an outside of the containment bag when the sheet is wrapped around the ratchet mechanism and the untensioned portion of the ratchet strap to form the containment bag.

5. The ratchet strap containment bag of claim 1, further comprising at least one securing strap attached to the second side of the sheet, wherein the second side will be an inside of the containment bag when the sheet is wrapped around the ratchet mechanism and the untensioned portion of the ratchet strap to form the containment bag, and wherein the at least one securing strap can secure at least part of the untensioned portion of the ratchet strap within the containment bag.

6. The ratchet strap containment bag of claim 1, wherein the flexible material of the sheet comprises at least one material selected from a group consisting of cotton, canvas, duck cloth, and nylon.
